(19) United States
(12) Patent Application Publication
(10) Pub. No.: US 2004/0250284 A1
(43) Pub. Date: Dec. 9, 2004

(54) Methods and apparatus for selecting baseband filter passband frequency and local oscillator frequencies

(76) Inventors: Zhiwei Dong, Austin, TX (US); Ramin Khoini-Poorfard, Austin, TX (US)

Correspondence Address: TROP PRUNER & HU, PC, 8554 KATY FREEWAY, SUITE 100, HOUSTON, TX, 77024, US

(21) Appl. No.: 10/814,769

(22) Filed: Mar. 31, 2004

Related U.S. Application Data
(63) Continuation-in-part of application No. 10/412,871, filed on Apr. 14, 2003.

(51) Int. Cl. H04N 7/18; H04N 7/20

(52) U.S. Cl. 725/68; 725/70

(57) ABSTRACT

In various embodiments, the present invention includes an apparatus that includes a receiver having multiple tuners. Such multiple tuners may each receive a signal channel using multiple local oscillator (LO) frequencies that do not interfere with each other. In certain embodiments, each tuner may have an associated VCO so that no multiplexer is needed. Also, the present invention includes methods to determine a minimum bandwidth for baseband filters of the receiver and an LO step frequency between different possible LO frequencies.

### REFERENCE TO EARLIER APPLICATION

This application is a continuation-in-part of U.S. patent application Ser. No. 10/412,871, filed Apr. 14, 2003, entitled “Integrated Multi-Tuner Satellite Receiver Architecture and Associated Method” by Ramin Khoini-Poorfard and Andrew W. Krone.

### TECHNICAL FIELD OF THE INVENTION

The present invention relates to receiver architectures for high frequency transmissions and more particularly to set-top box receiver architectures for satellite television communications.

### BACKGROUND

In general, an ideal receiver architecture for an integrated circuit from a bill-of-material point of view is usually a direct down conversion (DDC) architecture. However, in practice, there are several issues that often prohibit the practical design of integrated circuits using DDC architectures. These issues typically include DC offset voltage and 1/f noise from baseband circuitry located on the integrated circuit. In mobile applications, such as with cellular phones, the DC offset voltage is a time varying entity which makes its cancellation a very difficult task. In other applications where mobility is not a concern, such as with satellite receivers, the DC offset voltage can be stored and cancelled, such as through the use of external storage capacitors. However, 1/f noise is still an issue and often degrades CMOS satellite tuners that use DDC architecture.

Conventional home satellite television systems utilize a fixed dish antenna to receive satellite communications. After receiving the satellite signal, the dish antenna circuitry sends a satellite spectrum signal to a satellite receiver or set-top box that is often located near a television through which the viewer desires to watch the satellite programming. This satellite receiver uses receive path circuitry to tune the program channel that was selected by the user. Throughout the world, the satellite channel spectrum sent to the set-top box is often structured to include 32 transponder channels between 950 MHz and 2150 MHz with each transponder channel carrying a number of different program channels. Each transponder will typically transmit multiple program channels that are time-multiplexed on one carrier signal. Alternatively, the multiple program channels may be frequency multiplexed within the output of each transponder. The total number of received program channels considering all the transponders together is typically well over 300 program channels.

Conventional architectures for set-top box satellite receivers include low intermediate-frequency (IF) architectures and DDC architectures. Low-IF architectures utilize two mixing frequencies. The first mixing frequency is designed to be a variable frequency used to mix the selected satellite transponder channel to a pre-selected IF frequency close to DC, and the second mixing frequency is designed to be the low-IF frequency used to mix the satellite spectrum to DC. Direct down conversion (DDC) architectures utilize a single mixing frequency. This mixing frequency is designed to be a variable frequency that is used to mix the selected satellite transponder channel directly to DC.

DDC architectures, however, suffer from disadvantages such as susceptibility to DC noise, 1/f noise and I/Q path imbalances. DDC architectures also often use narrow-band phase-lock-loop circuitry (PLLs), which typically utilize LC-based voltage controlled oscillators (VCOs). Low-IF architectures, like DDC architectures, also typically require the use of such narrow-band PLLs with LC-based VCOs. Such LC-based VCOs are often difficult to tune over wide frequency ranges and often are prone to magnetically pick up any magnetically radiated noise. In addition, interference problems arise because the center frequency for the selected transponder channel and the DDC mixing signal are typically at the same frequency or are very close in frequency. To solve this interference problem, some systems have implemented receivers where the DDC mixing frequency is double (or half) of what the required frequency is, and at the mixer input, a divider (or doubler) translates the DDC mixing signal into the wanted frequency. Furthermore, where two tuners are desired on the same integrated circuit, two DDC receivers, as well as two low-IF receivers, will have a tendency to interfere with each other, and their VCOs also have a tendency to inter-lock into one another, particularly where the selected transponder channels for each tuner are close together.

Another problem exists in satellite receivers regarding use of a baseband filter. As bandwidth of the baseband filter increases, the bandwidth problems of amplifiers or transconductors used in the filter makes design of the filter difficult. Similarly, the larger the bandwidth of the baseband filter, analog-to-digital (ADC) sampling rates may also be raised, making system design more difficult. Thus a need exists to avoid interference between multiple VCOs and a further need exists to reduce the passband width of a baseband filter of a receiver.

### SUMMARY OF THE INVENTION

In one embodiment, the present invention includes a method and apparatus to receive satellite signal spectrums and determine multiple local oscillator (LO) frequencies that do not interfere with each other. Further, in selecting one or more new LO's for new channels to be tuned, selected LO's for present channels need not be changed. Further, the LO frequencies may be selected to be outside of the signal band of a respective signal channel, yet the down-converted signal channel will be within the passband width of an associated baseband filter of the receiver. Also, the present invention includes methods to determine appropriate bandwidths for baseband filters and an LO step frequency between different LO frequencies.

### BRIEF DESCRIPTION OF THE DRAWINGS

It is noted that the appended drawings illustrate only exemplary embodiments of the invention and are, therefore, not to be considered limiting of its scope, for the invention may admit to other equally effective embodiments.

FIG. 1A is a block diagram for an example satellite set-top box environment within which the receiver architecture of the present invention could be utilized.

FIG. 1B is a block diagram for example satellite set-top box circuitry that may include a receiver architecture according to the present invention.

FIG. 1C is a block diagram of basic receiver architecture according to the present invention utilizing a large-step local oscillator.

FIG. 2A is a diagram of an example channel spectrum signal having LO frequency selection regions in accordance with one embodiment of the present invention.

FIG. 2B is a diagram of an example channel spectrum signal having LO frequency selection regions in accordance with a second embodiment of the present invention.

FIG. 2C is a diagram of an example channel spectrum signal having a third signal channel with a worst case selection of LO frequencies.

FIG. 2D is a diagram of an example channel spectrum signal having a third signal channel with a selection of LO frequency in accordance with one embodiment of the present invention.

FIG. 3A is a flow diagram of a method for selecting a LO frequency in accordance with one embodiment of the present invention.

FIG. 3B is a flow diagram of a method for selecting a LO frequency in accordance with a second embodiment of the present invention.

FIG. 3C is a flow diagram of a method for selecting a LO frequency in accordance with a third embodiment of the present invention.

FIG. 3D is a flow diagram of a method for selecting a LO frequency in accordance with a fourth embodiment of the present invention.

FIG. 4 is an example embodiment for the basic receiver architecture using a wide-band analog-to-digital converter and a narrow band tunable bandpass analog-to-digital converter, respectively.

FIG. 5 is a block diagram for a two receiver architecture located on a single integrated circuit in accordance with one embodiment of the present invention.

FIG. 6 is a block diagram for a four receiver architecture located on a single integrated circuit in accordance with one embodiment of the present invention.

### DETAILED DESCRIPTION

The present invention provides single and multi-tuner receiver architectures and associated methods to provide initial analog course tuning of desired channels within a received signal spectrum. Also, the present invention provides algorithms to determine suitable bandwidths for a baseband filter of the receiver, a local oscillator (LO) step frequency, and other parameters to be used in selecting LO frequencies for use in down mixing an incoming signal spectrum.

In the description below, the signal spectrum is primarily described with respect to a satellite transponder channel spectrum; however, embodiments of the present invention may be used with other channel signal spectrums utilized by other systems, if desired.

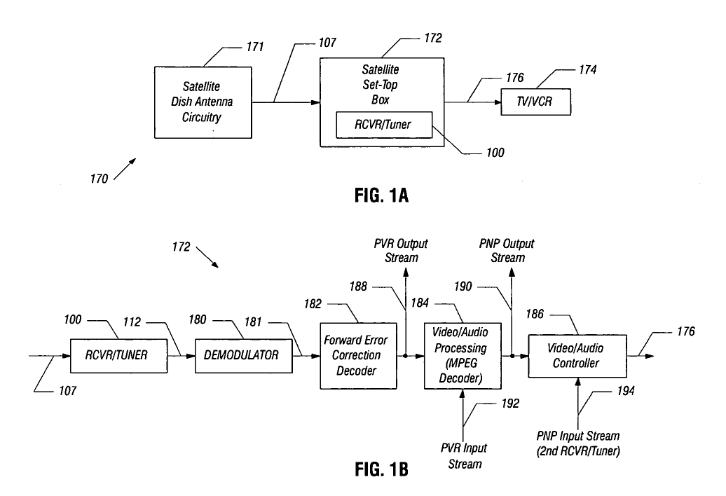

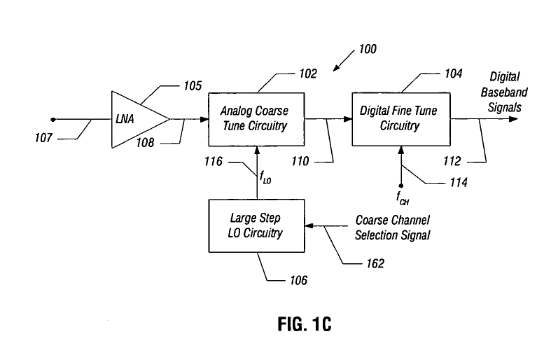

FIG. 1A is a block diagram for an example satellite set-top box environment 170 within which the receiver or tuner architecture 100 of the present invention could be utilized. In the embodiment depicted, a satellite set-top box 172 receives an input signal spectrum from satellite dish antenna circuitry 171. The satellite set-top box 172 processes this signal spectrum in part utilizing the receiver/tuner circuitry 100. The output from the satellite set-top box 172 is then provided to a television, a videocassette recorder (VCR) or other device as represented by the TV/VCR block 174.

FIG. 1B is a block diagram for example circuitry for a satellite set-top box 172 that could include the receiver architecture 100 of the present invention. The input signal spectrum 107 can be, for example, 32 transponder channels between 950 MHz and 2150 MHz with each transponder channel carrying a number of different program channels. This signal spectrum 107 can be processed by the receiver/tuner 100 to provide digital baseband output signals 112 that represent a tuned transponder channel. These output signals 112 can then be processed by a demodulator 180 that can tune one of the program channels within the tuned transponder channel. The output signal 181 from the demodulator, which represents a tuned program channel within the transponder channel that was tuned by the receiver/tuner 100, can then be processed with a forward error correction decoder 182 to produce a digital output stream. This digital output stream is typically the data stream that is stored by personal video recorders (PVRS) for later use and viewing by a user, as represented by the PVR output stream 188. The output of the decoder 182, or the stored PVR data as represented by PVR input stream 192, can then be processed by video/audio processing circuitry 184 that can include processing circuitry such as an MPEG decoder. The output of the processing circuitry 184 is typically the digital video data stream that represents the program channel and is used for picture-in-picture (PnP) operations, for example, where the set-top box circuitry 172 includes two tuners with one tuner providing the primary viewing feed and a second tuner providing the PnP viewing feed. The output of the processing circuitry 184, as well as a PnP input stream 194 from a second tuner if a second tuner is being utilized for PnP operations, can be processed by a video/audio controller 186 to generate a video output signal 176 that can subsequently be utilized, for example, with a TV or VCR. Additional tuners could also be used, if desired.

FIG. 1C is a block diagram of basic receiver architecture 100 according to the present invention utilizing a large-step LO circuitry 106. Input signal 107, for example from a satellite dish antenna or other source, is received and passed through a low noise automatic-gain amplifier (LNA) 105. In the embodiments described herein, it is assumed that the input signal 107 is a signal spectrum that includes multiple channels, such as a satellite television signals that includes 32 transponder channels between the frequencies of 950 MHz and 2150 MHz. The output signal 108 from LNA 105 is initially tuned with analog coarse tune circuitry 102 utilizing a LO mixing frequency (f_{LO}) provided by large-step LO circuitry 106. The large-step LO circuitry 106 also receives a coarse channel selection signal 162.

As discussed below, signal 162 may be determined based on a desired passband of a baseband filter and consideration of avoidance of noise and interference from LO circuitry associated with other receivers. The resulting coarsely tuned signal 110 is then subjected to digital fine tune circuitry 104 utilizing the center frequency (f_{CH}) 114 (also referred to herein as “f_{signal}”) for the desired channel to produce digital baseband signals 112. The digital fine tune circuitry 104 may include an analog-to-digital converter (ADC) and a baseband filter.

In certain embodiments, coarse tune circuitry 102 may include two mixers to generate an output Q signal that is offset by a phase shift of 90 degrees from an output I signal. To provide these two signals, a LO mixing frequency (f_{LO}) and a dual divide-by-two and quadrature shifter (÷2/90°) may be used. In other embodiments, other manners of frequency division, such as a divide-by-four operation, may be used. Also, no frequency division may be used in other embodiments such that the LO mixing frequency (f_{LO}) 116 is directly used to down mix I and Q signals.

The large-step local oscillator 106 may generate a mixing signal at one of a plurality of predetermined frequencies. The output LO frequency is selected based upon the channel within the spectrum that is desired to be tuned. The output LO frequencies can be organized and uniformly or non-uniformly spaced as desired. As one example, the output LO frequencies can be a fixed bandwidth apart from each other and can span the entire input channel spectrum signal 108. The local oscillator mixing frequency (f_{LO}) 116 may be generated using phase-lock-loop (PLL) circuitry, in one embodiment. In such an embodiment, a voltage controlled oscillator (VCO), such as an LC-tank oscillator or an RC-based oscillator may be used.

In various embodiments, a baseband filter's passband and LO step frequency (i.e., a step frequency between candidate LO frequencies) for two or more satellite tuners may be selected to acquire the required signals, to eliminate the effects of 1/f noise and DC offset voltage, to avoid cross talk of the VCOs used in the large step LO circuitry 106, to avoid the harmonic of one VCO affecting other VCOs, and to cancel input signal channel frequency errors.

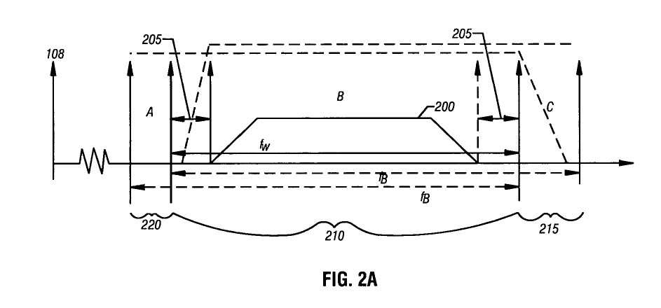

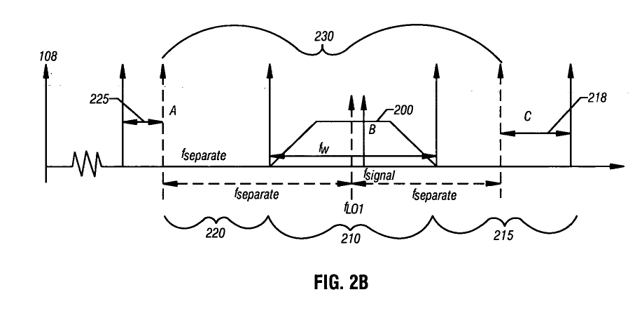

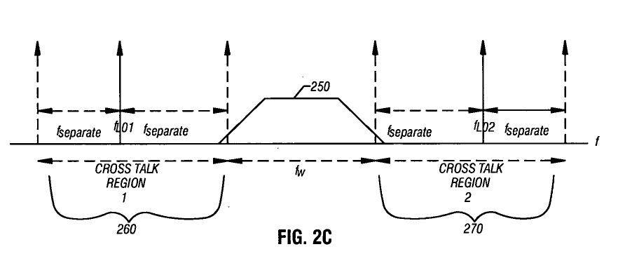

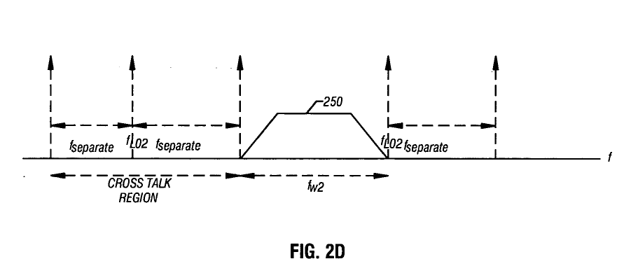

Referring now to FIG. 2A, shown is a diagram of an example satellite signal spectrum in accordance with one embodiment of the present invention. As shown in FIG. 2A, satellite spectrum 108 includes a first signal channel 200 that is within a first frequency region 210 (i.e., frequency region B). Frequency region 210 is surrounded by two adjacent frequency regions, namely frequency region A 220 and frequency region C 215. As will be discussed further below, frequency region A 220 and frequency region C 215 may be used as LO frequency selection regions, and one or both of these regions may include a LO frequency that is to be used to downmix first signal channel 200 to a frequency near DC.

As shown in FIG. 2A, first signal channel 200 has a bandwidth smaller than the bandwidth of frequency region 210. This is because frequency region 210 includes a pair of offset frequencies 205 (i.e., f_{noise-offset}) that may be used to offset a LO frequency from one of regions A and C to avoid 1/f noise and DC offset voltage noise. As shown in FIG. 2A, frequency region B 210 has a bandwidth equal to f_{W}, which is the frequency width of the signal channel, taking into account noise offset regions 205. In various embodiments, the value of offset regions 205 may vary. In certain embodiments, offset regions 205 may be between approximately 8 and 10 MHz, although the scope of the present invention is not so limited.

Similarly, shown in FIG. 2A, a passband width f_{B} of a baseband filter which may be used to filter the downmixed signal may be equal to the width of region B 210 (i.e., f_{W}) and either one of regions A 220 or region C 215. Thus, it is desired that a LO frequency used to downmix signal channel 200 be located within region A 220 or region C 215 so that information contained in signal channel 200 is obtained without information loss.

That is, if there is no LO frequency located in regions A or C, the LO frequency will either: (1) locate in region B, which causes a loss of information; (2) or locate outside of regions A and C, which makes the signal frequency locate outside of the passband of the filter and causes that part of the signal to be attenuated. As seen in FIG. 2A, the width of regions A, B and C totally is 2f_{B}−f_{w}, and the width of regions A or C are same: f_{B}−f_{w}. For a given f_{B} and a LO step frequency (f_{LO-step}), a smaller f_{W} makes regions A and C wider, and makes the number of LO frequencies in regions A and C larger.

In a continuous frequency band with a channel width of f, the smallest possible number (Nₛ) of LO frequencies and the largest possible number (Nₗ) of LO frequencies have the following relationship:

f=Nₛ·f_{LO-step}+df, Nₗ=Nₛ+1, 0≦df≦f_{LO-step} (EQ1).

Table 1 below shows the smallest passband frequency (f_{B}) of a baseband filter for a given Ns_{AC}, f_{W}, and f_{LO-step}, where m is any possible positive integer. As discussed above, a smaller f_{B} is desired to improve receiver performance and simplify design.

TABLE 1

| Ns_{AC} | 1 | 2 | 3 | 4 | 5 |
|---|---|---|---|---|---|
| f_{B} − f_{w} − | f_{LO-step} − | f_{LO-step} | 2f_{LO-step} − | 2f_{LO-step} | 3f_{LO-step} − |
| f_{noise-offset} | df_{fw/2} | | df_{fw/2} | | df_{fw/2} |
| Best f_{B} − f_{w} | 1/2f_{LO-step} | f_{LO-step} | 3/2f_{LO-step} | 2f_{LO-step} | 5/2f_{LO-step} |
| Best | f_{w}/m | n/a | f_{w}/m | n/a | f_{w}/m |
| f_{LO-step} | | | | | |

From Table 1 the expression for f_{B} is:

$${f}_{B} \geq {f}_{W} + {f}_{noise \text{-} offset} + \frac{{N}_{{s}_{A C}}}{2} \cdot {f}_{LO \text{-} step} + \frac{{( - 1 )}^{{N}_{{s}_{A C}} + 1} + 1}{4} \cdot ( {f}_{LO \text{-} step} - d {f}_{W} ) \qquad \text{(EQ 2)}$$

, where Ns_{AC} is the smallest number of LO frequencies in regions A and C.

Referring now to FIG. 2B, shown is an example satellite signal spectrum showing a crosstalk region in accordance with an embodiment of the present invention. Such an embodiment may be, for example, a two tuner receiver. As shown in FIG. 2B, satellite spectrum 108 includes a first frequency region B 210 that includes a second signal channel 200 with a center frequency of f_{signal2} that is desired to be tuned by a receiver. Note that for simplicity, in FIG. 2B the noise-offset regions 205 of FIG. 2A are not shown, however, it is to be understood that such regions may be present to prevent noise in a desired channel signal, and it is understood that f_{W} may include these offset regions.

As shown in FIG. 2B, a first LO frequency (f_{LO1}) is present in second signal channel 200. When the second signal channel 200 is desired to be acquired, a second LO frequency (f_{LO2}) may be selected. In various embodiments, the second LO frequency should be separated from the first LO frequency (f_{LO1}) by at least an amount equal to fₛₑₚₐᵣₐₜₑ to avoid crosstalk between the two VCOs for the two LO frequencies. As shown in FIG. 2B, a crosstalk region 230 may be equal to two times fₛₑₚₐᵣₐₜₑ. While the width of a crosstalk region may vary, in certain embodiments such a crosstalk region may be between approximately 60-70 MHz wide, although the scope of the present invention is not so limited. If the second LO frequency is selected from within crosstalk region 230, crosstalk may occur between the two VCOs. Accordingly, in various embodiments the second LO frequency may be selected from region 225 or region 218, which are subregions within region A 220 and region C 215, respectively, that exist outside of crosstalk region 230.

In certain embodiments, the crosstalk problem may be resolved by setting f_{LO-step} larger than fₛₑₚₐᵣₐₜₑ such that there is no crosstalk, regardless of which LO frequency is chosen. In other embodiments, f_{LO-step} may be made smaller and the number Ns_{AC} made larger to avoid crosstalk. Normally, a smaller f_{LO-step} may cause a smaller filter bandwidth and ADC sampling frequency, which make circuit design easier. A larger f_{LO-step} may be selected only when a smaller f_{LO-step} does not make the filter bandwidth and ADC sampling frequency smaller, in certain embodiments.

If f_{LO-step} is selected to be larger than fₛₑₚₐᵣₐₜₑ, two situations may exist: (1) the second signal can use the LO of the first channel (e.g., using a MUX); and (2) the second signal does not use the first channel LO (i.e., no MUX is used). In various embodiments, it may be desirable to avoid use of a MUX in such a two tuner receiver.

For the first situation to avoid a worst case in which f_{signal} is as far away as possible from the nearest LO frequency not in the second channel, f_{LO-step} may be set to be slightly larger so f_{LO-step} times some integer is larger than f_{W}, so that there is at least one LO frequency available in region A or C. Then from Table 1, where Ns_{AC}=1, f_{B} may be determined.

For the second situation, Ns_{AC}=1 cannot be selected, otherwise there may be only one LO frequency for the second signal, and if this frequency is the same as the LO frequency for the first signal channel, there is no choice for the second signal. So Ns_{AC}=2 is selected, and from Table 1, the smallest f_{B} is:

f_{B}≧fₛₑₚₐᵣₐₜₑ+f_{W} (EQ3).

In embodiments where f_{LO-step} is smaller than fₛₑₚₐᵣₐₜₑ, there are two situations that may occur. First, the crosstalk region of the first LO covers all or part of one of the two LO selection regions (i.e., region A or region C) of a second signal channel; second, the crosstalk area covers part of both regions A and C. (The crosstalk area cannot cover all of regions A and C, otherwise there would be no LO frequency choice for the second channel.)

For the first situation, the LO frequencies in one of the two LO selection regions (region A or region C) cannot be used. Since there is at least one LO frequency to be used for the second channel, Ns_{AC} is at least 2. From Table 1, another limitation for f_{B} is:

f_{B}≧f_{LO-step}+f_{W} (EQ4).

The second situation occurs when fₛₑₚₐᵣₐₜₑ>f_{W}/2, otherwise, the crosstalk area cannot cover part of both region A and region C. The LO frequency that can be used for a second signal and is nearest to f_{signal2}, and which should be Nlₛₑₚₐᵣₐₜₑ·f_{LO-step} away from f_{LO1}. In this case, f_{B} is:

f_{B}≧Nlₛₑₚₐᵣₐₜₑ·f_{LO-step}+f_{W}/2−|f_{signal2}−f_{LO1}| (EQ5)

where |f_{signal2}−f_{LO1}|≧0. So the worst case is |f_{signal2}−f_{LO1}|=0, and f_{B} is:

f_{B}≧Nlₛₑₚₐᵣₐₜₑ·f_{LO-step}+f_{W}/2 (EQ6).

Since Nlₛₑₚₐᵣₐₜₑ·f_{LO-step}=fₛₑₚₐᵣₐₜₑ occurs only when fₛₑₚₐᵣₐₜₑ is some integer times f_{LO-step}, the equality is valid. Selecting f_{LO-step} such that fₛₑₚₐᵣₐₜₑ is an integer multiple of f_{LO-step} can therefore make f_{B} smaller.

Comparing Equation 3 with Equation 4 and Equation 6, f_{LO-step}<fₛₑₚₐᵣₐₜₑ may make f_{b} smaller and thus no MUX is needed for Equation 4 and Equation 6. Thus for a two tuner system, f_{LO-step}<fₛₑₚₐᵣₐₜₑ is used, and no MUX is needed in any such case.

In designing a multi-tuner receiver having more than two tuners (and therefore more than 2 LO frequencies are desired), crosstalk between the VCOs may be avoided in similar fashion to the two VCO embodiment discussed above. In certain embodiments, two situations may be present: (1) one LO frequency can be used for several signal channels; and (2) one LO frequency can be used only for one signal channel.

In the first situation, suppose there are N TV channels that potentially may be tuned using an N tuner receiver. According to the first situation, one LO frequency may be used for several of the N signal channels. In such an embodiment, for f_{LO-step} larger than fₛₑₚₐᵣₐₜₑ, crosstalk issues are not applicable and one LO frequency may be used for several channels. Then, there are no limits on the LO selection. Accordingly, Ns_{AC} may be selected to be equal to one. Then using Table 1 above, the appropriate f_{B} may be obtained. As discussed above, a smaller f_{LO-step} may make f_{b} smaller (or better).

For a three tuner receiver, now consider f_{LO-step}<fₛₑₚₐᵣₐₜₑ where a MUX is used. If N=3, the worst case for f_{B} is the case of the largest distance between the first two LO frequencies when the LO frequency for the third channel must be selected from one of these two LO frequencies, for which f_{B}≧f_{w}+fₛₑₚₐᵣₐₜₑ. Referring now to FIG. 2C, shown is a diagram of a signal spectrum that may occur in a three tuner receiver in a worst case situation where a second LO frequency is not carefully selected. As shown in FIG. 2C, a third signal channel 250 has a width of f_{W}. Further shown in FIG. 2C is a first local oscillator frequency (f_{LO1}) having a crosstalk region (i.e., crosstalk region 1) 260 and a second LO frequency (f_{LO2}) having a crosstalk region (i.e., crosstalk region 2) 270.

Fortunately, this worst case may be eliminated by first carefully selecting the second LO frequency (f_{LO2}). Referring now to FIG. 2C, if the second signal channel is on the right side of the f_{LO2} frequency, then another LO with a larger frequency may be chosen; then there are more LO choices between the first two LO's. If it is on the left side of f_{LO2}, since f_{LO-step} is smaller than fₛₑₚₐᵣₐₜₑ, another choice is available between these two worst case LO's for the second LO. Thus the new distance between the first two LO's with no LO available for the third signal gets smaller.

Referring now to FIG. 2D, shown is a diagram of a satellite signal spectrum for a three channel tuner in accordance with an embodiment of the present invention. As shown in FIG. 2D, the second LO frequency may be carefully selected to eliminate the worst case as shown above in FIG. 2C. Accordingly, as shown in FIG. 2D, a second LO frequency may be selected to be about f_{w}+fₛₑₚₐᵣₐₜₑ away from f_{LO1}.

At this case,

f_{B}≧f_{W}/2+(Nlₛₑₚₐᵣₐₜₑ+Nl_{fw})·fₗₒ₋ₛₜₑₚ/2≧f_{w}+1/2fₛₑₚₐᵣₐₜₑ [EQ 6.1]

where Nlₛₑₚₐᵣₐₜₑ is the largest number of possible LO frequencies located in a frequency region of fₛₑₚₐᵣₐₜₑ. Thus the worst case for the third LO frequency may be eliminated by choosing f_{LO2} carefully. Normally, the value of Equation 6.1 is smaller than F_{w}+fₛₑₚₐᵣₐₜₑ−df_{w}/2 (from Table 1), so f_{LO-step}<fₛₑₚₐᵣₐₜₑ may be selected.

For the situation where no MUX is used, and f_{LO-step}>=fₛₑₚₐᵣₐₜₑ, the worst case is that three signals may be present at the exact same frequency, which means there must be 3 LO's in region A and region C. From Table 1, we get

$${f}_{B} \geq f w + {2}_{fseparate} - \frac{d f w}{2} . \qquad \text{(EQ 7)}$$

When f_{LO-step}<fₛₑₚₐᵣₐₜₑ, the worst case is the same as the worst case when one LO can be used for several channels, except the third LO cannot select one of the first two LO's, which is shown in FIG. 2D. Thus, the third LO must be fₛₑₚₐᵣₐₜₑ apart from f_{LO1} or f_{LO2}. Thus:

$${f}_{B} \geq \frac{f w}{2} + ( 3 {Nl}_{separate} + {Nl}_{fw} ) \cdot \frac{{f}_{lo \text{-} step}}{2} . \qquad \text{(EQ 8)}$$

Normally, (EQ8)≦(EQ7) so f_{LO-step}<fₛₑₚₐᵣₐₜₑ can make f_{B} smaller (better), and thus f_{LO-step}<fₛₑₚₐᵣₐₜₑ is used.

From the above analysis, for N=2, f_{B} can get fw/2 smaller (or better) when f_{LO-step}<fₛₑₚₐᵣₐₜₑ is chosen instead of f_{LO-step}>=fₛₑₚₐᵣₐₜₑ. For N=3, f_{B} can get better for f_{LO-step}<fₛₑₚₐᵣₐₜₑ, but at some special case, f_{B} is the same for f_{LO-step}<fₛₑₚₐᵣₐₜₑ and f_{LO-step}>=fₛₑₚₐᵣₐₜₑ.

When N≧4 and f_{LO-step}≧fₛₑₚₐᵣₐₜₑ, f_{B} may be the same (i.e., no worse) as f_{B} when f_{LO}<fₛₑₚₐᵣₐₜₑ. In such manner, when using a MUX, f_{B} may be chosen using Ns_{AC}=1 in Table 1 (meaning there is only one available LO in regions A and C). Thus when a first signal channel is received, its available LO may be chosen from its available LO's (i.e., one or two available LO's). When the next signal channel is received, if its available LO is the same as an earlier signal's LO, that LO may be multiplexed to the new signal channel. Otherwise, the available LO for that channel may be used.

In certain embodiments when N≧4 and f_{LO-step}≧fₛₑₚₐᵣₐₜₑ and no MUX is available, f_{B} may be chosen using Ns_{AC}=N in Table 1 (meaning there are N LO frequencies available in regions A and C). In such manner, when a first signal is received, one of its N available LO's is chosen. When a next channel is received, its LO is chosen to be a frequency not occupied by the earlier signal.

Because of a frequency error of the LO in a low noise blockdown converter (LNB) of a satellite receiver, there is some error for the center frequency (f_{signal}) of the signal channel. Since tuning methods in accordance with embodiments of the present invention are related to the center frequency of the signal channel, this error may affect tuning. There are two ways to eliminate this error. First, the error may be considered in the frequency for 1/f noise and DC offset, which makes this frequency larger, and thus may make the passband frequency of baseband filter larger. Second, after this error is known, the channel is re-tuned using the error. In certain embodiments, this may be preferable, because only a first acquired channel need be re-tuned, and re-tuning when watching TV is not necessary, as the error may be saved in a storage medium of the system (e.g., a nonvolatile memory or the like). Then, when the TV is turned on, this error may be automatically used to correct the center frequency of the signal channel.

In various embodiments, a harmonic of one VCO near the frequency of a second VCO may be avoided in like manner to avoiding VCO crosstalk. That is, if one VCO's harmonic frequency is near another VCO, some crosstalk may occur. The area of harmonic frequency which causes crosstalk may simply be treated as another crosstalk region. Normally, this crosstalk region affects LO frequency selection only when the two used LO frequencies are close to one another, and one is from a VCO frequency divided by 4, and the other is from another VCO frequency divided by two. Since this harmonic crosstalk area is much smaller than the original crosstalk region, if the original crosstalk region is considered in LO frequency selection, this harmonic crosstalk area is covered automatically.

Another issue is that when one LO frequency derived from a VCO frequency divided by four and this VCO frequency divided by two is still located in the signal channel (i.e., there are at least two crosstalk regions for one LO frequency). Fortunately, these two crosstalk regions are at least 0.9 GHz apart, and only one of them affects LO frequency selection. When the LO frequency is selected, only the crosstalk region affecting the selection should be considered.

By now, all analysis for selecting a baseband filter's passband frequency and LO step frequency has been described. Table 2 below provides the best choices for a filter's passband frequency by carefully choosing LO step frequencies for a given number of tuners (N), and number of LO's for a given VCO.

TABLE 2

| | # of | | | | |
|---|---|---|---|---|---|
| # of | LO's for | | | | |
| Tuners | one VCO | f_{B} expression | Best f_{LO-step} | Best f_{B} | Condition |
| N = 1 | 1 | f _{W} + f_{LO-step} − (df_{fw})/2 | f_{w}/m | f_{w} + f_{LO-step}/2 | m as larger |
| | | | | | as possible |
| N = 2 | 1 and 2 | f_{w}/2 + Nlₛₑₚₐᵣₐₜₑ · f_{LO-step} | fₛₑₚₐᵣₐₜₑ/m | fₛₑₚₐᵣₐₜₑ + f_{w}/2 | f_{w} < 2 · fₛₑₚₐᵣₐₜₑ |
| | | f_{w} + f_{LO-step} | as small as | f_{w} + f_{LO-step} | f_{w} ≧ 2 · fₛₑₚₐᵣₐₜₑ |
| | | | possible | | |
| N = 3 | Several | f_{w}/2 + (Nlₛₑₚₐᵣₐₜₑ + Nl_{fw} · f_{LO-step}/2 | f_{w}/m1 and | f_{w} + fₛₑₚₐᵣₐₜₑ/2 | n/a |
| | | | fₛₑₚₐᵣₐₜₑ/m2 | | |
| | 1 | (f_{w} +(3 · Nlₛₑₚₐᵣₐₜₑ +N;_{fw}) · f_{LO-step})/2 | f_{w}/m1 and | f_{w} + · fₛₑₚₐᵣₐₜₑ/2 | n/a |
| | | | fₛₑₚₐᵣₐₜₑ/m2 | | |
| N ≧ 4 | Several | f_{w} + f_{LO-step} − dfw/2 | fₛₑₚₐᵣₐₜₑ | f_{w} + fₛₑₚₐᵣₐₜₑ/2 | n/a |
| N ≧ 4 even | 1 | ${f}_{w} + \frac{N}{2} \cdot {f}_{LO - step}$ | fₛₑₚₐᵣₐₜₑ | ${f}_{w} + \frac{N}{2} \cdot {f}_{separate}$ | n/a |
| N ≧ 4 odd | 1 | f_{w} + (N · Nlₛₑₚₐᵣₐₜₑ + 1) · f_{LO-step} − df_{w}/2 | f_{w}m1 and fₛₑₚₐᵣₐₜₑ/m2 | ${f}_{w} + \frac{N}{2} \cdot {f}_{separate}$ | n/a |

When f_{noise-offset} for 1/f noise and DC offset is considered, all f_{W}'s in Table 2 may be replaced by f_{W}+2f_{noise-offset}, and the resulting f_{B} minus f_{noise-offset} is the final passband frequency of the filter.

Thus in various embodiments, in designing a multi-tuner receiver a baseband filter's passband frequency and LO step frequency may be selected to make the best choice for an unavoidable worst case condition for a given number of tuners present in the receiver.

Embodiments of the present invention may also implement a LO tuning algorithm that essentially tries to find the best choice for a given condition. The considerations behind the algorithm are: (1) to avoid 1/f noise and DC offset, the LO frequency should be at some distance away from the signal channel; and (2) the performance of the baseband filter requires the LO frequency to be as near as possible to the signal channel to make group delay and passband attenuation smaller.

Based on these considerations, an algorithm in accordance with an embodiment of the present invention may make the center frequency of the signal channel (i.e., f_{signal}) at the middle of the passband of the filter. To make this possible, any given signal channel may be considered as the widest channel for the signal spectrum, and the LO frequency may be selected accordingly. If

$${f}_{signal} = {Ns}_{signal} \cdot {f}_{LO \text{-} step} + d {f}_{signal} , \\ {f}_{WW} / 2 = {Ns}_{{f}_{WW} / 2} \cdot {f}_{LO \text{-} step} + d \frac{{f}_{WW}}{2} \qquad \text{(EQ 9)}$$

where f_{WW} is the frequency width of the widest signal channel. Let:

$${Ns}_{channel} = {Ns}_{{F}_{WW} / 2} , {df}_{channel} = d \frac{{f}_{WW}}{2} \qquad \text{(EQ 10)}$$

Then, the LO frequency should satisfy the following equations:

f_{LO}≦f_{signal}−f_{WW}/2=(Ns_{signal}−Ns_{channel})·f_{LO-step}+(df_{signal}−df_{channel}) (EQ11)

f_{LO}≧f_{signal}+f_{WW}/2=(Ns_{signal}+Ns_{channel})·f_{LO-step}+(df_{signal}+df_{channel}) (EQ12)

Since df_{signal}−df_{channel} may be larger or smaller than zero, and df_{signal}+df_{channel} may be larger or smaller than f_{LO-step}, four possible LO frequencies, Ns_{signal}−Ns_{channel}−1, Ns_{signal}−Ns_{channel}, Ns_{signal}−Ns_{channel}+1, and Ns_{signal}−Ns_{channel}+2, may be selected for the first incoming signal channel or un-affect a second channel by the crosstalk region of the first LO frequency. The conditions for the LO frequencies are shown in Table 3.

TABLE 3

| | Conditions | | |
|---|---|---|---|
| | | df_{channel} + | df_{signal} − |
| N_{LO} | df_{channel} − df_{signal} | df_{signal} − f_{LO-step} | f_{LO-step}/2 |
| NS_{signal} − NS_{channel} − 1 | >0 | >0 | <0 |
| NS_{signal} − NS_{channel} | <=0 | <0 | <=0 |
| | <0 | >0 | >0 |
| NS_{signal} + NS_{channel} + 1 | <0 | <0 | >=0 |
| | >=0 | <0 | <0 |
| NS_{signal} + NS_{channel} + 2 | >0 | >0 | >0 |

For a second TV signal channel, three situations may exist: (1) no effect by the crosstalk region of the first LO frequency; (2) the crosstalk region affects possible LO frequencies on one side of the second signal channel; and (3) the crosstalk region affects all possible LO frequencies on both sides of the second signal channel. A flag may be used to show which side of the signal channel is affected by the crosstalk region of first LO frequency; if the flag is positive, then the left side of the signal channel is affected; if the flag is negative; the right side of the signal channel is affected, although the scope of the present invention is not so limited. Ns_{AC} and df_{channel} may be redefined when both sides of the signal channel are affected, as shown in Table 4. The possible LO frequencies for the second signal channel and the conditions for the frequencies are shown in Table 5.

TABLE 4

| | no effect on the first | | |
|---|---|---|---|
| Condition | LO | affecting one side | affecting both sides |
| Expression | \|f_{signal2} − f_{LO1}\|≧ N1ₛₑₚₐᵣₐₜₑ + f_{WW}/2 | \|f_{signal2} − f_{LO1}\|≧ N1ₛₑₚₐᵣₐₜₑ − f_{WW}/2 | \|f_{signal2} − f_{LO1}\|< N1ₛₑₚₐᵣₐₜₑ − f_{WW}/2 |
| df_{channel} | d(f_{WW}/2) | d(f_{WW}/2) | d(fₛₑₚₐᵣₐₜₑ − \|f_{signal2} − f_{LO1}\|) |
| NS_{channel} | Ns_{(f}_{WW}/2) | Ns_{(f}_{WW}/2) | NS_{(f}ₛₑₚₐᵣₐₜₑ−\|f_{signal2}−f_{LO1}\|) |
| flag | n/a | f_{signal2} − f_{LO1} | f_{signal2} − f_{LO1} |

The conditions for the signal channel tuning algorithm for a second signal channel which is affected by a first LO frequency is shown in Table 5 below:

TABLE 5

| N_{LO} | Conditions |
|---|---|
| NS_{signal} − NS_{channel} − 1 | flag <0 and df_{signal} < df_{channel} |
| NS_{signal} − NS_{channel} | flag <0 and df_{channel} ≦ df_{signal} |
| NS_{signal} + NS_{channel} + 1 | flag >0 and df_{channel} ≦ f_{LO-step} − df_{signal} |
| NS_{signal} + NS_{channel} + 2 | flag >0 and f_{LO-step} − df_{signal} < df_{channel} |

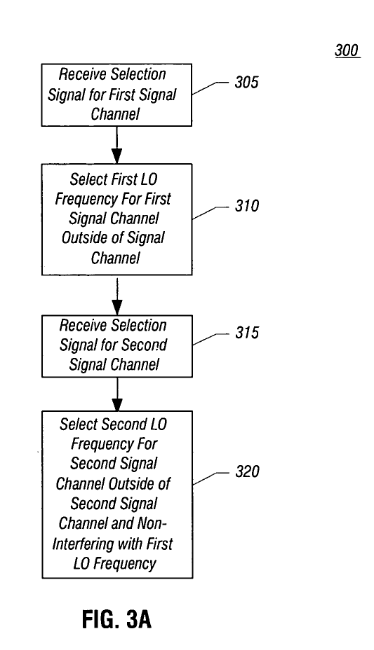

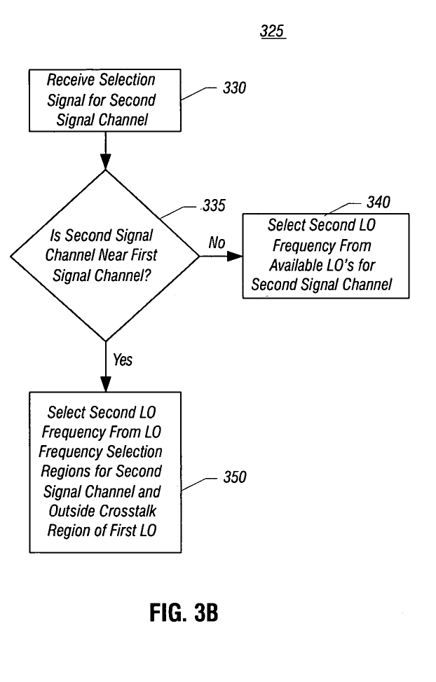

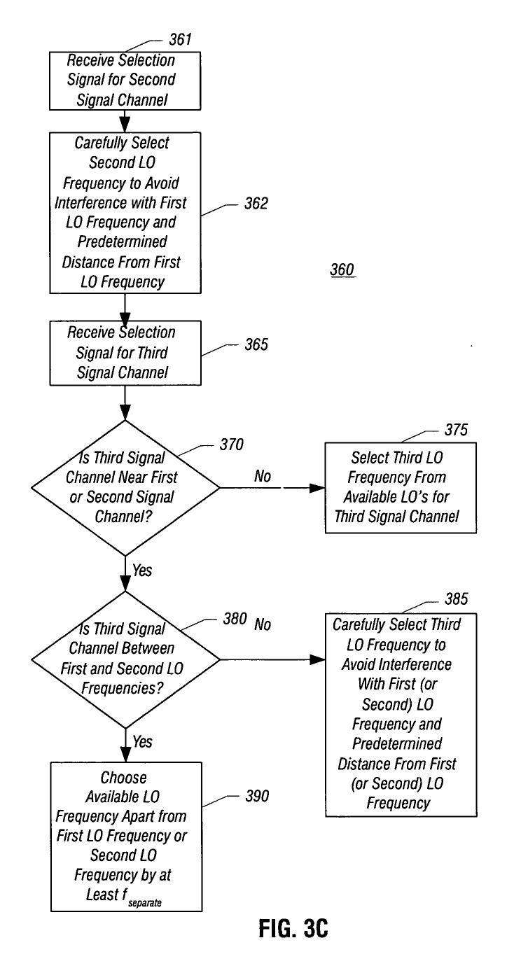

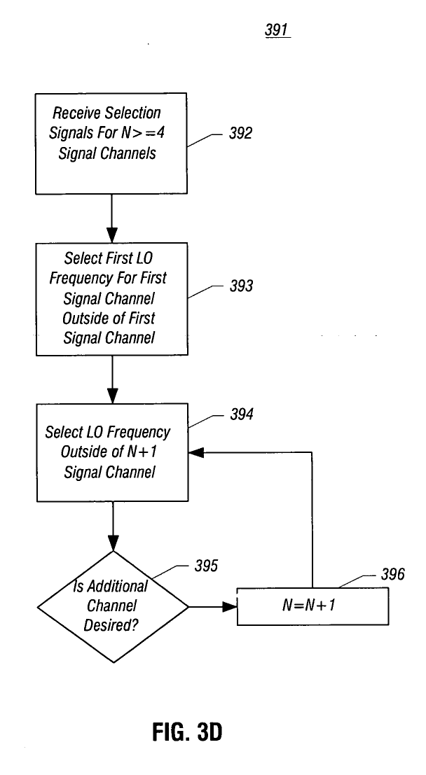

Referring now to FIG. 3A, shown is a flow diagram of a method for tuning a satellite receiver in accordance with one embodiment of the present invention. Specifically, FIG. 3A shows a method 300 that may be used to tune a first signal channel desired by a user of a satellite receiver that has two tuners. As shown in FIG. 3A, method 300 may begin by receiving a selection signal for a first signal channel (block 305). Such a selection signal may be received from a user who desires to watch a given TV channel.

A first LO frequency may be selected that is outside of the first signal channel (block 310). By selecting the first LO frequency to be outside of the first signal channel, the first LO frequency may be used as a mixing signal to provide down conversion of the first signal channel to a frequency range around DC. A resulting tuned analog signal may then be subjected to digital fine tuning, for example, using digital fine tune circuitry 104 of FIG. 1C.

In various embodiments, the first LO frequency may be selected to be further outside of the first signal channel by at least a first amount f_{noise-offset} to avoid the effects of 1/f noise and DC offset errors.

Still referring to FIG. 3A, it may later be desired by a user of the satellite receiver to concurrently tune into a second signal channel, for example, for use with PnP, DVR, or the like. In such an embodiment, a selection signal may be received for the second signal channel (block 315). A second LO frequency may then be selected for the second signal channel that is outside of the second signal channel and that also does not interfere with the first LO frequency (block 320). That is, the second LO frequency should be selected such that the VCO that generates the second LO frequency does not interfere with the VCO that generates the first LO frequency.

Referring now to FIG. 3B, shown is a flow diagram of a method for tuning a second signal channel in a satellite receiver in accordance with an embodiment of the present invention. FIG. 3B may be used in selecting LO frequencies for a two tuner receiver, and further details how to select the second LO frequency to avoid interference with the first LO frequency. As shown in FIG. 3B, method 325 begins by receiving a selection signal for a second signal channel (block 330).

It may be determined whether the second signal channel is near the first signal channel (diamond 335). In this embodiment, “near” means that the two signal channels are close enough in frequency that undesired interference may occur if a LO frequency is not carefully selected. For example, two signal channels may be near each other if fₛₑₚₐᵣₐₜₑ for the first LO frequency extends into either LO frequency selection region of a second signal channel. While what is considered to be near a given signal may vary in different embodiments, in certain embodiments, a second channel may be considered to be near a first channel if is within between approximately 50 MHz and 80 MHz of the first channel.

If it is determined that the second signal channel is not near the first signal channel, the second LO frequency may be selected from available LO frequencies for the second signal channel (block 340). For example, in such instance the second LO frequency may be selected from either of a first and second LO selection region surrounding the second signal channel.

If instead it is determined that the second signal channel is near the first signal channel, the second LO frequency must be selected carefully so as to avoid interference between the two VCOs. As shown in FIG. 3B, the second LO frequency may be chosen from the LO frequency selection regions for the second channel and further be chosen such that it is outside the crosstalk region of the first LO (block 350). In such manner, the second LO frequency will not interfere with the first LO frequency, i.e., the two VCOs generating the LO frequencies do not create crosstalk.

Referring now to FIG. 3C, shown is a flow diagram of a method for selecting a LO frequencies for second and third signal channels in accordance with an embodiment of the present invention for use with a three tuner satellite receiver. For example, such a receiver may be a three tuner system without multiplexers.

As shown in FIG. 3C, method 360 begins by receiving a selection signal for a second signal channel (block 361). While not shown in FIG. 3C, it is to be understood that prior to selection of a second signal channel, a first signal channel has been tuned using a first LO frequency. Then the second LO frequency may be carefully selected (block 362). More specifically, the second LO frequency may be selected to both avoid interference with an existing first LO frequency and further be carefully selected such that it is at least a predetermined distance away from the first LO frequency. In such manner, corner cases and a worst case scenario, as discussed above with regard to FIG. 2C may be avoided. Specifically, in various embodiments, the second LO frequency may be selected to avoid certain LO frequencies, namely those that are NL_{fseparate}+Nl_{fW}+1 to Nl_{fseparate}+Nsf_{W}+NLfₛₑₚₐᵣₐₜₑ·f_{LO-step} away from the first LO frequency. In such manner, a worst case situation may be avoided if a third signal channel is desired to be used in the three tuner receiver system.

Then a selection signal for a third signal channel is received (block 365). Next it may be determined whether the third signal channel is near either of the first or second signal channels (diamond 370). As discussed above, in this instance near means whether it is close enough in frequency that undesired interference may occur if a LO frequency is not carefully selected (e.g., if fₛₑₚₐᵣₐₜₑ for either of the pending channels extends into a LO selection region for the third signal channel).

If the third signal channel is not near either the first or second signal channels, the third LO frequency may be selected from the available LO frequencies for the third signal channel (block 375). That is, if the third signal channel is far enough away from both of the first and second channels, the third LO frequency may be selected from either of a first or second LO frequency selection region for the third signal channel.

Alternately, if it is determined that the third signal channel is near one or both of the signal channels, it may then be determined whether the third signal channel is between the first and second signal LO frequencies (diamond 380). If the third signal channel is not in between the two existing LO frequencies, the third LO frequency may be carefully selected to avoid interference with the first or second LO frequencies and be a predetermined distance away from the first or second LO frequencies (block 385).

If instead the third signal channel is between the LO frequencies for the first and second channels, the third signal channel may choose an available LO frequency that is apart from the first and second LO frequencies by at least fₛₑₚₐᵣₐₜₑ (block 390). In alternate embodiments, for example, where multiplexers are present in a receiver having multiple tuners (e.g., a three tuner system), a LO frequency for the third channel may be multiplexed from one of the first or second LO frequencies.

While discussed herein, for example, for a two tuner system, receiving a first selection signal for a first channel, a second selection signal for a second channel and so forth, it is to be understood that in other embodiments a first signal may be received and a first channel tuned, then a second channel tuned. However, the first channel may then be turned off, and at a later time a third channel may be desired to be tuned. In such embodiments, the LO frequency for the third channel may be selected in light of the existing second channel but not the original first channel that is no longer being tuned. Further, all parameters relating to the second channel may be maintained unchanged while tuning the third signal channel.

Referring now to FIG. 3D, shown is a flow diagram of a method for selecting LO frequencies for four or more signal channels. As shown in FIG. 3D, method 391 begins by receiving selection signal for the N signal channels (block 392). The LO frequency for the first signal channel may be selected to be outside of that signal channel (block 393). As discussed above, this frequency may also be selected to be outside of a noise-offset region surrounding the first LO frequency. Next, the LO frequency for the N+1 signal channel may be selected to be outside of that signal channel (and also outside of a noise-offset region thereof) (block 394). For example, f_{LO-step} may be greater than fₛₑₚₐᵣₐₜₑ such that additional signal channels may select a LO frequency that does not interfere with an existing LO frequency. Otherwise, one of the earlier LO frequencies may be selected and multiplexed for the N+1 signal channel. Next, it may be determined whether additional signal channels are desired (diamond 395). If so, N is set equal to N+1 (block 396) and control returns to block 394.

Such methods may improve the performance and efficiency of a receiver architecture by providing multiple LO frequencies and helping to resolve multiple channels whose frequencies are relatively close to each other.

It is often desirable to include two or more receivers in a single integrated circuit and to reduce the frequency range within which the digital fine tune circuitry 104 must operate. Also, as discussed above, it is advantageous to increase the frequency step between LO frequencies (f_{LO-step}) so that adjacent LO frequencies from two or more separate receivers in an integrated multi-tuner satellite receiver are far enough apart to avoid interference with each other. However, it is also advantageous to reduce f_{LO-step} to reduce the frequency range within which the digital fine tune circuitry 104 must operate and to relax the design specifications for the digital fine tune circuitry 104, including, for example, low pass filter (LPF) circuitry and analog-to-digital conversion (ADC) circuitry. Thus, in certain embodiments, a frequency step between 5 and 50 MHz may be selected as a f_{LO-step}, and in one particular embodiment, a f_{LO-step} of 10 MHz may be selected. Other frequency steps may be reasonable choices when considering the trade-off between minimizing the frequency step while still keeping adjacent LO frequencies separated to avoid interference. Of course, other frequency steps or configurations may be chosen depending upon the particular design requirements involved.

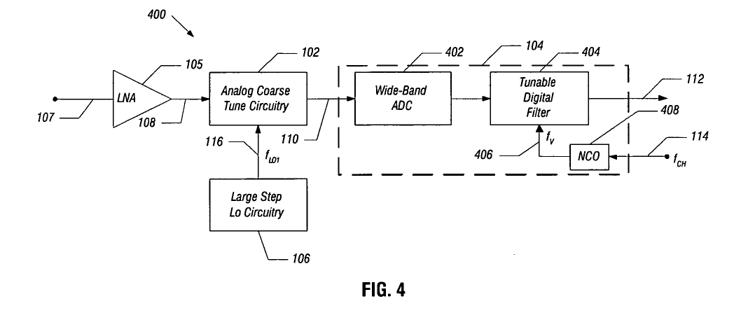

FIG. 4 is an example implementation for a basic receiver architecture using a wide-band ADC for the digital fine tune circuitry 104. In particular, embodiment 400 of FIG. 4 utilizes a wide-band ADC 402 that receives coarsely tuned signal 110 and provides a digital output to a tunable digital filter 404, which in turn outputs the digital baseband signals 112. For fine tuning the desired channel within the signal 110, the tunable digital filter 404 utilizes a variable frequency (f_{V}) 406 generated, for example, by a numerically controlled oscillator (NCO) 408 that in turn receives the center frequency (f_{CH}) 114 for the desired channel.

By fine tuning the coarsely tuned channel spectrum, the receiver 400 does not mix the desired channel down to a fixed target IF frequency and then mix the desired channel to DC. Rather, this implementation uses the analog coarse tune circuitry 102 to mix the desired channel down to a variable location within a frequency range around DC, and then digital conversion and digital filtering is performed directly on this coarsely tuned channel spectrum.

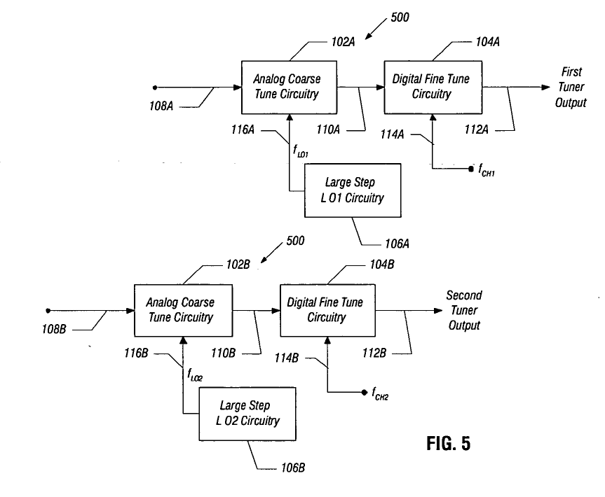

FIG. 5 is a block diagram of an embodiment 500 for a two receiver architecture located on a single integrated circuit. In general, this embodiment 500 duplicates the circuitry of FIG. 1C to produce a dual receiver architecture. The first receiver includes analog coarse tune circuitry 102A, large-step LO1 circuitry 106A (which outputs a first LO mixing frequency (f_{LO1})116A), and digital fine tune circuitry 104A (which receives a first center frequency (f_{CH1}) 114A for a first desired channel to be tuned). As discussed above, the first receiver coarsely tunes the input channel spectrum 108A to produce the intermediate coarsely tuned channel signal 110A and then digitally processes this signal to finely tune the channel and to produce digital baseband signals for the first tuner output 112A. Similarly, the second receiver includes analog coarse tune circuitry 102B, large-step L02 circuitry 106B (which outputs a second LO mixing frequency (f_{LO2})116B), and digital fine tune circuitry 104B (which receives a second center frequency (f_{CH2}) 114B for a second desired channel to be tuned). The second receiver coarsely tunes the input channel spectrum 108AB to produce the intermediate coarsely tuned channel signal 110B and then digitally processes this signal to finely tune the channel to produce digital baseband signals for the second tuner output 112B. By using embodiments of the present invention, LO frequencies for the two tuners may be selected to avoid interference, precluding the need for a multiplexer.

The architecture of the present invention may be utilized to integrate additional receivers within a single integrated circuit. For example, if four tuners were utilized, additional receiver circuitry could be integrated with that shown in FIG. 5 to provide additional analog coarse tuning circuitry, digital fine tuning circuitry and LO circuitry for a third receiver and additional analog coarse tuning circuitry, digital fine tuning circuitry and LO circuitry for a fourth receiver. As discussed above, a variety of selection techniques could be implemented for the LO frequencies provided by the different LO circuitries with respect to the multiple receivers such that interfering overlaps of the LO mixing frequencies could be avoided.

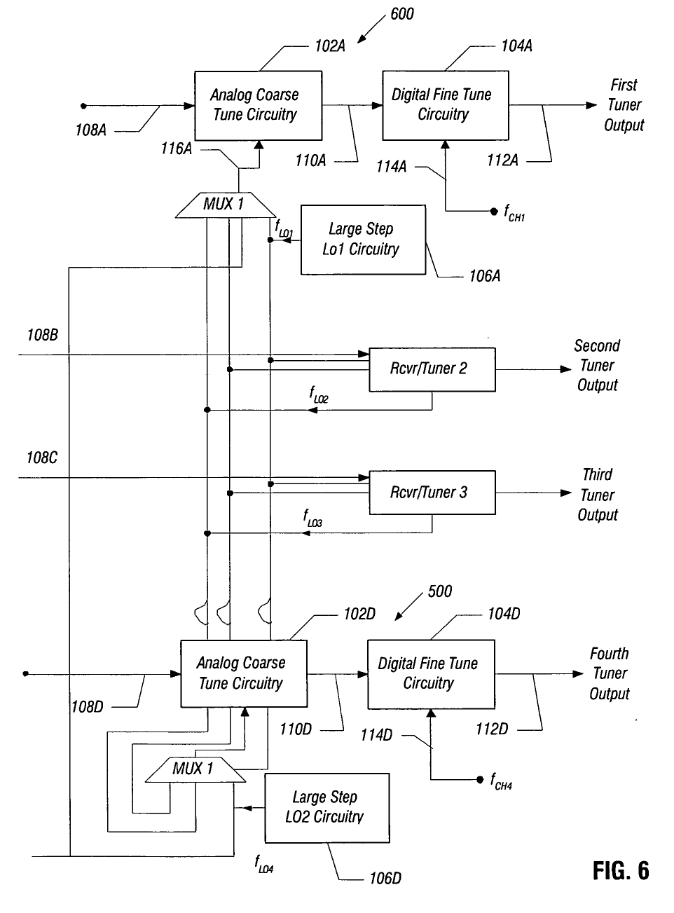

Referring now to FIG. 6, shown is a block diagram of a satellite receiver in accordance with an embodiment of the present invention with four recievers. As shown in FIG. 6, the receiver 600 includes four tuners 600a-600d. For simplicity, first tuner 600a and fourth tuner 600d are shown in detail, and second tuner 600b and third tuner 600c are shown as blocks. However, it is to be understood that each of the four tuners shown in FIG. 6 may include similar tuning circuitry to that shown in first tuner 600a and fourth tuner 600d.

As shown in FIG. 6, each tuner includes its own large step LO circuitry 606 that may be used to generate a LO frequency. In accordance with an embodiment of the present invention, each of the large step LO circuitries 606a-d may be coupled to a multiplexer 620a-d (i.e., MUX 1-4). Multiplexers 620a-d may receive control signals (not shown in FIG. 6) from a large step LO circuitry 606 or another location in satellite receiver 600 so that it may select an appropriate one of the LO frequencies for use in the given tuner. For example, multiplexers 620a-d may be used to select, for example a LO frequency generated by large step LO circuitry 606a for use in multiple tuners.

While not shown in FIG. 6, it is to be understood that large step circuitry 606 or another location in satellite receiver 450 may receive information regarding presently existing signal channels and LO frequencies used therein, which may be used by an algorithm discussed above to determine a LO frequency for an additional signal channel.

Furthermore, in certain embodiments, various parameters may be determined ahead of time for a satellite receiver, for example, during design, development and/or initial programming thereof. Such parameters may be stored in a nonvolatile memory in satellite receiver 600. Such parameters may include, in certain embodiments a bandwidth of a widest signal channel within a signal spectrum (i.e., f_{WW}), a step frequency (i.e., f_{LO-step}), and a separation frequency to avoid crosstalk (i.e., fₛₑₚₐᵣₐₜᵢₒₙ). In such embodiments, using these parameters, in addition to the known frequency and LO frequency of a first signal channel and frequency of a desired second signal channel, a LO frequency for the second channel may be determined that does not interfere with the LO frequency of the first channel. Similarly, additional signal channels may be acquired using additional LO frequencies or a present LO frequency to similarly avoid interference.

Thus in various embodiments having any number of tuners within a receiver, 1/f noise and DC offset noise may be eliminated, crosstalk between VCO's may be avoided, and an input signal frequency error (i.e., an LNB error) may be canceled. Further in embodiments having two tuners, no MUX is needed, which simplifies system design, and avoids the harmonic of one VCO affecting another VCO.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
receiving a satellite signal spectrum in a receiver; and
determining a local oscillator (LO) frequency for a signal channel within the satellite signal spectrum, the LO frequency being away from a center of a widest signal channel by greater than half of a signal band of the widest signal channel and less than half of a passband width of a baseband filter of the receiver.

2. The method of claim 1, further comprising selecting the LO frequency from a first LO selection region and a second LO selection region, each of which are adjacent to a signal channel.

3. The method of claim 2, further comprising selecting the LO frequency to be outside of the signal band of the signal channel by at least a first amount to avoid 1/f noise and a DC offset effect.

4. The method of claim 1, further comprising determining an error value corresponding to a frequency error of a LO generating the LO frequency.

5. The method of claim 4, further comprising storing the error value in a storage medium.

6. The method of claim 1, wherein the baseband filter has a smallest passband width that is wider than a width of the widest signal channel and half of a LO-step frequency, wherein the receiver comprises one tuner.

7. The method of claim 1, further comprising:
mixing the satellite signal spectrum with the LO frequency to obtain a downmixed signal; and
filtering the downmixed signal using the baseband filter.

8. The method of claim 7, further comprising selecting the LO frequency to cause a center frequency of the downmixed signal to be at a center of a passband of the baseband filter.

9. The method of claim 1, further comprising determining a new LO frequency for a new signal channel within the satellite signal spectrum, the new LO frequency being outside of a signal band of the new signal channel and an offset region surrounding the new signal channel.

10. The method of claim 9, further comprising selecting the new LO frequency so that it does not interfere with one or more existing LO frequencies.

11. The method of claim 10, further comprising selecting the new LO frequency from a LO candidate selection region that is outside a crosstalk region surrounding the one or more existing LO frequencies.

12. The method of claim 11, wherein the LO candidate selection region is outside a crosstalk region surrounding harmonics of the one or more existing LO frequencies.

13. The method of claim 11, further comprising maintaining parameters of existing signal channels when tuning the new signal channel.

14. A receiver comprising:
a first mixer to mix a received signal spectrum with a first local oscillator (LO) frequency to obtain a first downmixed signal;
a first baseband filter to filter the first downmixed signal to obtain a first digital baseband signal for a first signal channel; and
a storage medium including information regarding a minimum filter bandwidth for the first baseband filter, the minimum filter bandwidth based upon a widest signal channel for the received signal spectrum and a separation frequency.

15. The receiver of claim 14, further comprising:
a plurality of mixers to each mix the received signal spectrum with one of a plurality of local oscillator (LO) frequencies to obtain a plurality of downmixed signals; and
a plurality of baseband filters to each filter one of the plurality of downmixed signals to obtain digital baseband signals for a plurality of signal channels.

16. The receiver of claim 15, wherein the minimum filter bandwidth is equal for the plurality of baseband filters of the receiver.

17. The receiver of claim 14, wherein the minimum filter bandwidth is determined based on a number of tuners within the receiver.

18. The receiver of claim 14, wherein a LO step frequency of the receiver is based on a number of tuners present in the receiver.

19. The receiver of claim 18, wherein the minimum filter bandwidth is at least equal to the LO step frequency and a width of the widest signal channel, wherein the receiver comprises two tuners.

20. The receiver of claim 18, wherein the minimum filter bandwidth is at least equal to half of a width of the widest signal channel and a predetermined value multiplied by the LO step frequency, wherein the receiver comprises three tuners.

21. The receiver of claim 18, wherein the minimum filter bandwidth is at least equal to a width of the widest signal channel and a predetermined value multiplied by the LO step frequency, wherein the receiver comprises four or more tuners.

22. The receiver of claim 14, wherein a LO step frequency of the receiver is greater than the separation frequency, wherein the receiver comprises at least four tuners.

23. The receiver of claim 14, wherein a LO step frequency of the receiver is less than the separation frequency, wherein the receiver comprises three or fewer tuners.

24. The receiver of claim 14, wherein the storage medium further includes instructions that if executed enable the receiver to select a new LO frequency that does not interfere with one or more existing LO frequencies.

25. The receiver of claim 24, wherein the storage medium further includes instructions that if executed enable the receiver to select the new LO frequency based on a value of the one or more existing LO frequencies and relative locations of one or more existing signal channels and a new signal channel.

26. An apparatus comprising:
a first tuner to receive a satellite signal spectrum;
a first oscillator to generate a first local oscillator (LO) frequency to be mixed with the satellite signal spectrum to obtain a first signal channel; and
a selection circuit to determine the first LO frequency, wherein the first LO frequency is outside of a signal band of the first signal channel and within a passband width of a first baseband filter of the first tuner.

27. The apparatus of claim 26, further comprising:
a second tuner to receive the satellite signal spectrum; and
a second oscillator to generate a second LO frequency to be mixed with the satellite signal spectrum to obtain a second signal channel.

28. The apparatus of claim 27, wherein the selection circuit is adapted to determine a new LO frequency, wherein the new LO frequency does not interfere with an existing LO frequency.

29. The apparatus of claim 28, wherein the selection circuit determines the new LO frequency based on a crosstalk region of the existing LO frequency and a frequency location of an existing signal channel and a new signal channel.

30. The apparatus of claim 27, further comprising:
a third tuner to receive the satellite signal spectrum; and
a third oscillator to generate a third LO frequency to be mixed with the satellite signal spectrum to obtain a third signal channel.

31. The apparatus of claim 30, wherein the selection circuit is adapted to determine the third LO frequency, wherein the third LO frequency does not interfere with the first LO frequency or the second LO frequency, wherein the apparatus comprises three tuners.

32. The apparatus of claim 30, wherein the selection circuit is adapted to select one of the first LO frequency or the second LO frequency for use in obtaining the third signal channel from the satellite signal spectrum, wherein the apparatus further comprises a multiplexer.

33. The apparatus of claim 30, further comprising:
a fourth tuner to receive the satellite signal spectrum; and
a fourth oscillator to generate a fourth LO frequency to be mixed with the satellite signal spectrum to obtain a fourth signal channel.

34. The apparatus of claim 33, wherein the selection circuit is adapted to determine the fourth LO frequency, wherein the fourth LO frequency does not interfere with the first LO frequency, the second LO frequency, or the third LO frequency.

35. The apparatus of claim 33, wherein the selection circuit is adapted to select one of the first LO frequency, the second LO frequency, or the third LO frequency for use in obtaining the fourth signal channel from the satellite signal spectrum, wherein the apparatus further comprises a multiplexer.

36. The apparatus of claim 33, wherein the first tuner, the second tuner, the third tuner, and the fourth tuner are adapted on a single integrated circuit.

37. A method comprising:
determining a smallest passband for at least one baseband filter of a receiver based on a widest received signal channel width and a separation frequency of the receiver.

38. The method of claim 37, wherein the smallest passband of the at least one baseband filter is at least equal to a local oscillator (LO) step frequency and a width of a signal channel, wherein the receiver comprises two tuners and the width of the signal channel is greater than or equal to two times the separation frequency.

39. The method of claim 37, wherein the smallest passband of the at least one baseband filter is at least equal to half of a width of a signal channel and a predetermined value multiplied by a local oscillator (LO) step frequency, wherein the receiver comprises three tuners and the width of the signal channel is less than two times the separation frequency.

40. The method of claim 37, wherein the smallest passband of the at least one baseband filter is at least equal to a width of a signal channel and a predetermined value multiplied by a local oscillator (LO) step frequency, wherein the receiver comprises at least four tuners.

41. The method of claim 37, further comprising setting a local oscillator (LO) step frequency for the receiver.

42. The method of claim 37, further comprising setting a crosstalk region for the receiver.
